(19) United States
(12) Patent Application Publication
(10) Pub. No.: US 2025/0270976 A1
(43) Pub. Date: Aug. 28, 2025

(54) ELECTRICAL POWER GENERATION SYSTEM

(71) Applicant: NOSMEK GREEN SOLUTIONS, INC., West Des Moines, IA (US)

(72) Inventor: Nsisuk Osmund Ekanem, Etsako West (NG)

(21) Appl. No.: 18/933,400

(22) Filed: Oct. 31, 2024

Related U.S. Application Data
(60) Provisional application No. 63/594,803, filed on Oct. 31, 2023.

(51) Int. Cl. F03B 17/02; F03B 11/00; F03B 13/00

(52) U.S. Cl. CPC F03B 17/025; F03B 11/00; F03B 13/00; F05B 2240/95

(57) ABSTRACT

An automated power generation system utilizes at least two separate specially designed piston tanks containing water or other liquid that moves within each separate piston housings in a generally vertical manner either upward due to buoyant forces or downward due to gravitational force to continuously pressurize and displace water or other liquid which is directed in a cyclic manner by means of a penstock to and through common power generating means such as a Pelton Turbine or other hydro turbines to generate electrical power and to operate the same for uninterrupted power supply for 24-hours per day, 7-days a week and 365 days a year. This cycle of power generation continues (not in the concept of perpetual motion) and obeys the law of conservation of energy as energy is neither created nor destroyed within the system but converted from one form to the other as needed

### CROSS REFERENCE TO RELATED APPLICATIONS

This application claims priority under 35 U.S.C. § 119 to provisional patent application U.S. Ser. No. 63/594,803, filed Oct. 31, 2023. The provisional patent application is herein incorporated by reference in its entirety, including without limitation, the specification, claims, and abstract, as well as any figures, tables, appendices, or drawings thereof.

### TECHNICAL FIELD

The present disclosure relates generally to energy generation, energy conversion, energy storage and, in particular, electrical energy generation based on effective use of gravity, Archimedes principle of buoyant force, principle of hydraulics, reciprocating pistons, material science, principle of moments, and established hydropower generation principles.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

With the exponential growth in global population currently projected by the United Nations to reach around 8.5 billion by 2030 and 9.7 billion in 2050 and the advances in technology and standards of living in society. This comes with a corresponding exponential rise in the overall demand for power to support food production, transportation, residential, and industrial manufacturing needs of this great human population. The power availability gap is worst in rural areas, where there is no access to established grid power hence, the need for decentralized power generation. More so, there is the urgent need to decarbonized power generation to help combat climate change by transitioning from fossil fuel to pure renewable power sources. Furthermore, there are enormous challenges associated with most current power generation systems. Some examples follow:
Nuclear Power Plant: This refers to power generation from the heat of atomic nuclear fission, nuclear decay or nuclear fusion of mostly Uranium and Plutonium. The heat energy is used to change water from liquid state to high-pressure steam that drives turbines to generate electricity. Substantial heat is generated which warms the earth adversely in Nuclear Power Plants thus requiring large volumes of scarce fresh water to cool the systems. Another drawback here is in the safety and issues of radiation hazards to life associated with nuclear fuel and nuclear waste. In addition, nuclear proliferation into nuclear weapons is a global concern.
Fossil Fuel Based Power Plant: This refers to every power plant that burns natural gas, petroleum and its derivatives and coal to generate electricity. Fossil fuels are non-renewable and have finite reserves. The combustion of fossil fuel produces greenhouse gases (GHG) such as carbon dioxide, a known cause of global warming leading to adverse climate change. There are other air pollutants from combustion of fossil fuels such as sulfur dioxide, nitrogen oxides, volatile organic compounds, and heavy metals. It also produces enormous heat of combustion which further adversely warms the earth.
Solar Power: Solar power is harnessed into electrical power through several methods, for example the use of photovoltaic cells (PV) to directly convert sunlight into electrical energy and the use of concentrated solar power (CSP) which uses lenses, mirrors, and tracking systems to focus a large area of sunlight into a small beam to heat water into steam to turn turbines for power. The major drawbacks to Solar power adoption are high cost per kilowatt, weather dependency, requires expensive energy storage system and above all requires very large horizontal area per kilowatt thus competing for land with agriculture and city expansion for human housing and settlement. More so, environmental studies show that covering ocean surfaces with solar panels blocks sunlight penetration and leads to adverse ecosystem disruptions. Solar power systems are vulnerable to extreme weather, heavy snow cover in winter, sandstorms and strong stormy wind.
Wind Power: This is tapping energy from wind using specially designed blades attached to a generator to capture wind energy and turns it into electricity. The main drawback is that it is dependent on the weather primarily wind speed and duration, thus power generation is intermittent, requires expensive storage system(s), has siting limitation and requires very large land area per kilowatt. Wind power systems are vulnerable to extreme weather, heavy snow cover in winter, sandstorms and strong stormy wind.
Hydropower: This refers to power generated from flowing water due to gravity using special turbines. It requires construction of expensive dams that inescapably impact negatively on aquatic life and natural ecosystems. It is limited by location because there must be sufficient geological gradients to create reasonable water head to drive the turbines. This implies also that there must be a body of flowing water such as a river. Advances in hydropower led to Pumped Hydropower Systems which require external power source to pump water back to the storage reservoir to continue to generate power. This comes at a high cost which narrows profit margins and make it less attractive for investors given the huge initial capital expenditure to install the Pumped Hydropower System.
Geothermal Power: Geothermal energy as the name implies refers to the original internal energy of the earth and stored energy due to radioactive decay of materials within the earth's core. Thus, this heat energy from earth's core is explored and harnessed to heat water into steam for power generation. Some other geothermal power involves direct heating by drilling into the earth core and pumping the molten rock and water to the earth surface. This molten rock releases a mixture of gases, notably hydrogen sulphide, carbon dioxide, ammonia and methane which causes acid rain and global warming. It is expensive and limited to locations near tectonic plates.
Tidal Power: This is power harnessed from ocean tides using specially designed turbines. The major drawback is the cost per kilowatt and the fact that its location limited as suitability is determined by tidal flow, tidal rise, ecosystem vulnerability and exposure to weather with attendant expensive upfront cost.

In the light of the foregoing, there exists a dire and timely need to help combat climate change and aid in the deep decarbonization of Earth's atmosphere by providing a greener and more cost-efficient source of electricity generation with no tangible carbon emissions and with the smallest area footprint per kilowatt to meet both industrial and domestic electricity demand for 24-hrs per day, 7-days a week, and 365-days per year.

While there have been improvements to technologies that generate electricity without the primary use of fossil fuels (see, e.g., U.S. Pat. No. 10,801,476, hereby incorporated by reference in its entirety), there can be further improvements. This can include but is not limited to a reduction in the size of systems or housing, as well as improvements to the efficiencies of such systems.

Thus, there exists a need in the art.

### SUMMARY

The following objects, features, advantages, aspects, and/or embodiments are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of any of the aspects and/or embodiments of the present disclosure to improve on or overcome the deficiencies in the art.

It is a further object, feature, and/or advantage of any of the aspects and/or embodiments of the present disclosure to reduce the depth and/or vertical heights of housings used with energy generation systems.

It is still yet a further object, feature, and/or advantage of any of the aspects and/or embodiments of the present disclosure to reduce and/or eliminate the need for pumping associated with liquid-based energy generation systems.

It is still yet a further object, feature, and/or advantage to provide continuous steady power, not intermittent—available at any time.

It is still yet a further object, feature, and/or advantage to provide power quality suitable for all kinds of loads and can withstand load surges.

It is still yet a further object, feature, and/or advantage to provide decentralized power generation, thereby ensuring less energy loss due to long distance transmission.

It is still yet a further object, feature, and/or advantage to provide dispatchable power generation, thereby ensuring that grids can adjust swiftly in response to the demand for electricity at any given time.

It is still yet a further object, feature, and/or advantage to provide flexible siting, lower capital cost, fast construction and commissioning, optimum water circulation, and early return on investment.

It is still yet a further object, feature, and/or advantage to provide a stealth power generation, where the power plant is built completely underground, thereby ensuring that cities or critical places can still be powered in the event of an enemy attack.

The systems disclosed herein can be used in a wide variety of locations where energy is required and utilizes a smaller footprint than previous systems.

It is preferred the apparatus be safe, cost effective, and durable. For example, the system can be adapted to resist excessive heat, static buildup, corrosion, and/or mechanical failures (e.g., cracking, crumbling, shearing, creeping) due to excessive impacts and/or prolonged exposure to tensile and/or compressive forces acting on the system.

Therefore, aspects and/or embodiments of the present disclosure include an innovative independent electrical power generating system controlled by a programmable logic controller (PLC) that relies on the interaction of the weight of a solid (i.e., steel) and weight of a liquid (i.e., water) due to gravity, buoyant forces, proprietary volume displacer unit(s), and at least two synchronized convertible piston and cylinder units each operating in separate housings to continuously pressurize a liquid (i.e., water), which is directed in a cyclic manner by means of a penstock into or through a hydro turbine (such as a Pelton Turbine or Francis Turbine) to generate electricity for uninterrupted power supply for 24-hours per day, 7-days a week and 365 days a year. This cycle of power generation continues (not in the concept of perpetual motion), and also obeys the law of conservation of energy as energy is neither created nor destroyed within the system but converted from one form to the other as needed, to provide electrical power that can be used on-demand or otherwise stored for future use.

Any of the objects, features, advantages, aspects, and/or embodiments disclosed herein can be integrated with one another, either in full or in part.

According to some aspects of the disclosure, an electrical power generating system includes at least two Main Piston Housings (MPH) containing a liquid substance such as water with a penstock for each MPH that conduct the liquid such as water out of it to a Common Power Generator (CPG); also a specially designed mechanism called Volume Displacer (VD) for each MPH that conducts the liquid (e.g., water out and into the MPH), a specially designed Convertible Liquid Ladened Piston (CLLP) positioned in each of the MPH, wherein the two pistons are movable vertically downward alternately in the MPH to displace an amount of the water contained in the lower part of the MPH; wherein the piston is movable downward, in part, by gravity. Note that the penstock valve should be opened partly or fully for power to be generated during the vertically downward stroke of the piston while the piston central doors are shut and the Pressurized Piston Barrel (PPB) recharge line is also shut.

According to some aspects of the disclosure, the system has a specially designed Volume Displacer (VD) that receives part of the water contained in the MPH such that the loaded CLLP moves vertically downward freely under air at atmospheric pressure to pressurize water beneath the piston seals and expel this pressurized water through the penstock to the Common Power Generator.

According to at least some aspects of the disclosure, the specially designed Volume Displacer also expels the water it receives back into the MPH after the piston has reached the point of substantially zero potential energy, which enables the CLLP to float to the point of maximum potential energy for the cycle to continue repeatedly.

According to at least some aspects of the disclosure, the specially designed volume displacer enables the piston tank to descend with only its tail submerged in water and ascend with the entire piston tank submerged under water or other liquid.

According to at least some aspects of the disclosure, the MPH has rails that guide the rollers on the CLLP as it moves vertically downward by gravitational force and vertically upward by buoyant forces.

According to some additional aspects of the present disclosure, the Common Power Generator (CPG) is a hydro-turbine such as a Pelton Turbine, Francis Turbine, Kaplan Turbine etc., which receives pressurized water stream from the penstock and converts it into electrical power.

According to at least some aspects of the disclosure, at least two Convertible Liquid Ladened Piston tanks are programmed to move in alternating manner such that when one piston tank is moving downward shortly before reaching the point of substantially zero potential energy the other Convertible Liquid Ladened Piston begins to move downward while the next piston moves upward synchronously to ensure uninterrupted power generation for 24-hours per day, 7-days a week, and 365 days a year. The power generated by one piston unit is used to power the other piston at point of zero power generation leveraging on buoyant forces to regain the piston's maximum potential energy.

According to at least some aspects of the disclosure, the cycle of power generation continues, and obeys the law of conservation of energy as energy is neither created nor destroyed within the system but converted from one form to the other as needed, to provide electrical power that can be used on demand or otherwise stored for future use

According to at least some aspects of the disclosure, the piston comprises at least one fixed air tank of calculated size, which can be positioned at the lower part of the CLLP to create substantial upthrust to lift the CLLP to the point of maximum potential energy when its central doors are open; a motorized hydraulic double acting hydraulic cylinder for opening and closing of the piston central doors, spring loaded landing pads, and a maintenance free set of seals that ensures pressurization without leakages.

According to at least some aspects of the disclosure, the piston with a mass of its frame and mass of water or other liquid contained in it moves downward under the influence of gravitational force acting vertically downward in air and moves upward when the piston central doors are open under the influence of buoyant forces acting vertically upward due to fixed volume of air tanks within the fully submerged piston.

According to at least some aspects of the disclosure, the penstock is fitted with controllable valves to selectively allow water to follow through it, directing it to the nuzzled end of the penstock where the water or other liquid jets out to strike the turbine blades interior of the ballast.

According to at least some aspects of the disclosure, there is the turbine water collector and draft pipe that channels the water after striking the turbine blade back to the Main Piston Housing in a cyclical manner.

According to at least some aspects of the disclosure, the Volume Displacer with a motorized double acting hydraulic cylinder press type mechanism has seals that mitigates water or other liquids within it from leaking, whereas, the Volume Displacer with a motorized geared screw press type mechanism has no seals in the main body of the Volume Displacer.

According to at least some aspects of the disclosure, the Volume Displacer with a motorized geared screw press mechanism has a water channel through which the liquid moves back and forth from the Main Piston Housing, no seals attached to the pressing drum but the drum has rollers on a rail to guide the upward and downward movement,

According to some aspects of the disclosure, a method of power generation comprises moving at least two Convertible Liquid Ladened Pistons in a vertical direction in a housing, with each piston in its own housing, to displace water disposed in the housing, the piston moving downward by gravity and upward by buoyancy, generating power as each piston moves downward.

According to at least some aspects of the disclosure, the step of moving the piston downward by gravity comprises closing CLLP doors to trap the liquid (i.e. water) while also opening the penstock motorized valve and operating the displacer to displace some volume of liquid (ie. water) from the Main Piston Housing.

According to at least some aspects of the disclosure, the Convertible Liquid Ladened Piston CLLP has spring loaded landing pads which could be fixed to its bottom or fixed to the floor of the Main Piston Housing or on both.

According to at least some aspects of the disclosure, the Convertible Liquid Ladened Piston CLLP brakes while ascending by closing its central doors before finally reaching the CLLP spring loaded stopper attached to the Main Piston Housing at the set point of maximum potential energy.

According to at least some aspects of the disclosure, the Convertible Liquid Ladened Piston CLLP brakes while descending by leveraging on buoyancy to open its central doors before finally reaching the CLLP spring loaded stoper attached to the Main Piston Housing base at the set point of substantially zero potential energy.

According to at least some aspects of the disclosure, the Convertible Liquid Ladened Piston CLLP has installed a maintenance free seal at the end of the CLLP plunger held fastened by means of the piston plate, bolts, and nuts. The seals can be made of various material such as silicone polymers or other petrochemical or natural polymers.

According to at least some aspects of the disclosure, the step of moving the piston upward by gravity comprises closing CLLP doors to allow water to flow through it while also opening the piston compression motorized barrel recharge valve.

According to at least some aspects of the disclosure, the step of opening or closing the CLLP central doors involve operation of a motorized hydraulic pump and hydraulic tank lined up to the double acting cylinder.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail. The drawings are presented for exemplary purposes and may not be to scale unless otherwise indicated.

FIG. 1 is a schematic view of an automated hydraulic hydropower system (AHHS) according to aspects and/or embodiments of the present disclosure.

FIG. 2 is a schematic view showing details of the power generation system of FIG. 1, including a sectional view to see the interior portions of the system.

FIG. 3 is an isometric view of a piston tank for use with the power generation system according to aspects of the present disclosure.

FIG. 4 is a front elevation view of the piston tank of FIG. 3.

FIG. 5 is a top plan view of the piston tank of FIG. 3.

FIG. 6 is a perspective view of an electric generator for use with the power generation system of the present disclosure.

FIG. 7 is a top plan view of the electric generator.

FIG. 8 is a front elevation view of the electric generator.

FIG. 9 is an end view of the electric generator.

FIG. 10 is a perspective view of a spring loaded leg assembly for use with the power generation system of the present disclosure.

FIG. 11 is a top plan view of the spring loaded leg assembly.

FIG. 12 is a front plan view of the spring loaded leg assembly.

FIG. 13 is a schematic diagram showing typical size specifications for a 100 MW AHHS power generating system according to the present disclosure.

FIG. 14 is a schematic and enlarged view of a volume displacer mechanism including a motorized geared screw press for use with an AHHS.

FIG. 14A is an enlarged portion of FIG. 14 labeled as 14A in FIG. 14.

FIG. 15A is a perspective view of a convertible liquid ladened piston including a maintenance free seal.

FIG. 15B is a front elevation view of the convertible liquid ladened piston of FIG. 15A.

FIG. 15C is a front elevation view of the piston in a piston tank.

FIG. 15D is another front elevation view of the convertible liquid ladened piston.

FIG. 15E is a top plan view of the piston.

FIG. 15F is a sectional view of the piston according to lines 15F in FIG. 15E.

FIG. 16A is a perspective view of a convertible liquid laden piston showing a piston central doors opening and closing mechanism.

FIG. 16B is a right elevation view of FIG. 16A.

FIG. 16C is a front elevation view of FIG. 16A.

FIG. 16D is a top plan view of FIG. 16A.

FIG. 16E is an enlarged view of a portion of FIG. 16C labeled as 16E in FIG. 16C.

FIG. 17 is a schematic view of a typical Pelton turbine installed as part of a AHHS according to aspects of the present disclosure.

FIG. 17A is an enlarged view of a portion of FIG. 17 labeled as 17A in FIG. 17.

FIG. 17B is a view of a portion of FIG. 17A.

FIG. 18A is a sectional view of a volume displacer operating mechanism (a motorized hydraulic press) in a lowered position which has replaced the motorized geared screw press of FIGS. 1 and 14.

FIG. 18B is a view of FIG. 18A with the volume displacer in a raised position.

FIG. 19 is an energy conversion schematic diagram for a typical AHHS according to embodiments of the present disclosure.

An artisan of ordinary skill in the art need not view, within isolated figure(s), the near infinite distinct combinations of features described in the following detailed description to facilitate an understanding of the present disclosure.

### DETAILED DESCRIPTION

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

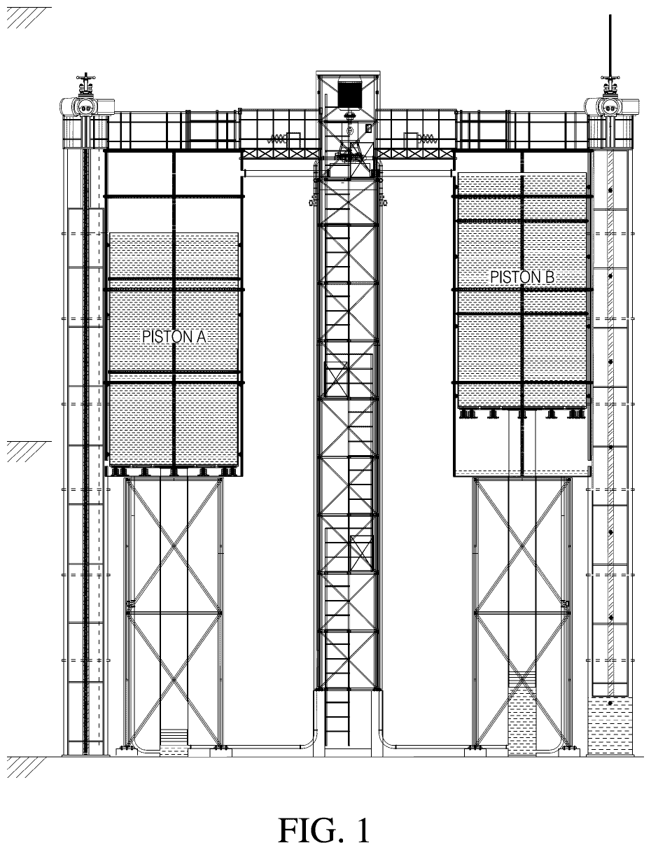

Referring now to the figures, a power generation system is provided. As shown in FIG. 1 and others, the power generation system includes first and second towers comprising housings. Adjacent each tower/housing is a displacement system. An amount of liquid, such as water, is included in the system, and the towers are connected via conduits, such as penstocks, to allow water to be transported from one tower to the other, and also to and through power generation members, such as turbines.

The reference numerals shown in FIG. 1 include the following:
1. Generator Roof: to protect the generator from weather.
2. Electric Generator: to convert mechanical energy to electrical energy.
3. Control Panel: to control entire programable logic controllers that runs the plant.
4. Pelton Turbine: to convert kinetic energy of the pressurized water to mechanical energy to do rotational work.
5. Turbine Draft Pipe and water collector: to collect water after impact on turbine blades and direct the liquid back to the main piston housing. It also serves as a liquid level equalization line between the two main piston housings.
6. Motorized Gate Valve: to control flow of liquid through the penstock.
7. Check Valve: to prevent backflow of liquid within the penstock.
8. Walkway: Provide access to personnel for operation and maintenance.
9. Motorized Geared Screw Press: to lower and raise the volume displacer as needed.
10. Rollers for piston plunger: : to reduce friction as the piston moves up and down,
11. Rail for piston plunger; to provide guide way for smooth movement of the piston rollers.
12. Body of Volume Displacer: to periodically control the level of liquid in the main piston housing.
13. Rollers for Volume Displacer: to reduce friction as the volume displacer moves up and down,
14. Water level in piston (Lower position): to indicate level of water when the piston is lowered
15. Piston Central Doors: to break the piston and allow water to flow through as the piston rises and trap water for power generation cycle when piston is at set point for power generation cycle.
16. Spring Loaded legs: to absorb shock from the piston as the piston lands at the bottom
17. Steel Support Structure for the tank: to provide structural support for the main piston housing
18. Ladder: to provide access to the top of the main piston housing to personnel for maintenance and operation
19. Penstock: direct pressurized water to the common turbine generator.
20. Concrete Foundation: to provide a solid base for the steel support structure holding the common turbine generator.
21. Steel Shaft for Displacer: to raise the displacer body up and down as needed.
22. Piston Plunger: to convert weight of piston to pressure force that pressurize liquid beneath the piston plate.
23. Water level in piston (raised position): to indicate water level when piston is raised.
24. Space filled with air at atmospheric pressure: to enable the piston to descend without upthrust from the liquid (ie water).
25. Water level in main piston housing: to provide: an indication of water level before piston begins to descend.
26. Piston Seal: to ensure sealing of the piston and barrel for proper pressurization of the liquid beneath the piston plate.
27. Motorized Valve: to control flow in the piston barrel recharge line.
28. Constant volume air tank; to provide needed upthrust to regenerate the piston to the point of maximum potential energy for power generation.
29. Water level in volume displacer: to indicate water level when volume displacer is raised.
30. Compression barrel recharge line: to recharge the compression barrel with liquid after each cycle of power generation.
31. Spring loaded CLLP stopper.
32. hydraulic tank and pump unit.
33. hydraulic pressure hose.

When the system shown in FIG. 1 is built, an external power source can be used to pump water underground water, river or water tanker where the liquid is water to fill the towers as required by design and to commission the power plant. Most external power stations burn fossil fuels such as coal, oil, and natural gas to generate electricity. Low-carbon power sources include nuclear power, and use of renewables such as solar, wind, geothermal, and hydroelectric. Any of the types of power stations are contemplated as external power sources to start the process, as well as to provide additional power during any needed time.

To commission the plant, the two Convertible Liquid Ladened Pistons (CLLP) are set to a point of maximum potential energy, then one of the towers is lined up with the turbine with the central doors of both Convertible Pistons Closed. A Volume Displacer in the first piston is lined up to Main Piston Housing to receive un-trapped water in the main piston housing, leaving the Convertible Liquid Ladened Piston to begin to descend, generating power. At this point, the external power source used to commission the plant is disconnected or otherwise stopped in terms of providing power to the system. Note that such external power source is only used to provide initial power for the automated controls of the system and volume displacers therefore, the power required is in the neighborhood of 5.150 MW to start up a 100 MW Automated Hydraulic Hydropower System (AHHPS) for example. When the descending Convertible Liquid Ladened Piston is near to the point of zero potential energy, the second set of Volume Displacers in the other tower is operated in like manner for the other piston to start to descend as the two penstock vales are fully open. After the first piston reaches a point of substantially zero potential energy or zero power generation, the load is switched to the second convertible piston and in this manner uninterrupted power generation is achieved. The Volume Displacer now pumps back or empties its reservoir back to the main piston housing enabling the dead convertible piston to ascend after opening its central doors and the piston barrel recharge line. This sequence is programmed into a Programmable Logic Controller or other automation controls controllers for fully automated operation without human interference.

A piston housing may have more than one volume displacer in a set depending on design.

An amount of liquid, such as water, is included in the system, and the towers are connected via conduits, such as penstocks, to allow water to be transported from one tower to the other, and also to and through power generation members, such as turbines.

It should be appreciated that the type and/or manner of power generation member is not to be limiting and may be referred to as turbines. A turbine is a rotary mechanical device that extracts energy from a fluid flow and converts it into useful work. The work produced can be used for generating electrical power when combined with a generator. For example, a water turbine may be used, such as Pelton turbine, a type of impulse water turbine; a Francis turbine, a type of widely used water turbine; a Kaplan turbine, a variation of the Francis Turbine; a Turgo turbine, a modified form of the Pelton wheel; a Tyson turbine, a conical water turbine with helical blades emerging partway down from the apex gradually increasing in radial dimension and decreasing in pitch as they spiral towards the base of the cone; and/or a Cross-flow turbine, also known as Banki-Michell turbine, or Ossberger turbine. However, any liquid turbine should be contemplated.

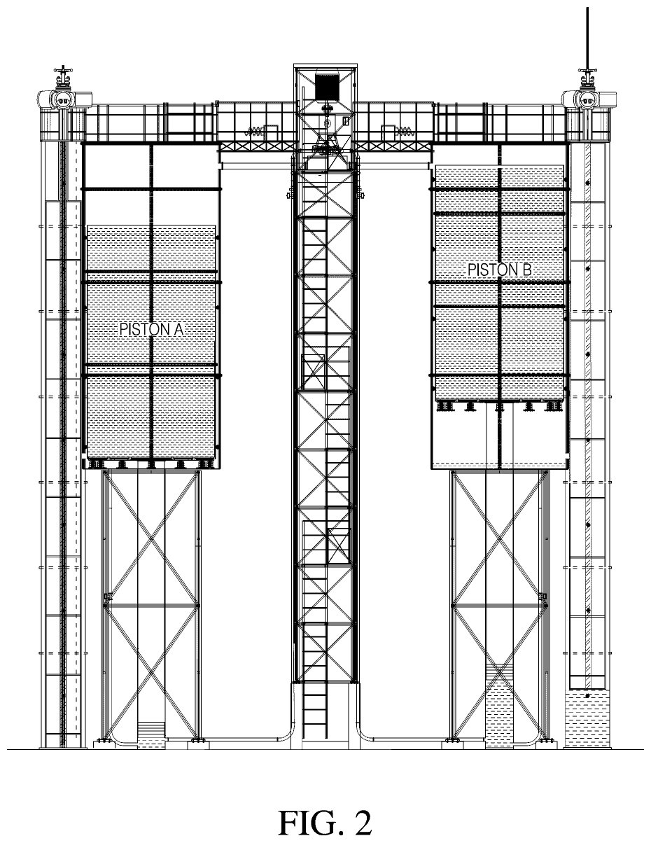

As shown in FIG. 2, additional aspects will be provided. The towers will include support structures to hold the system. A piston tank including a piston and a cylinder tank are housed in the towers, and the towers include generally corresponding shapes and sizes to the components. An amount of water is included in the towers. The piston, under the force of gravity, will move generally downward (see, e.g., the right tower in FIG. 2). Water can be added to the piston via an electrical pump to overcome the buoyancy of the piston. This downward movement will move any water in the tower downward and towards a penstock. The penstock is a conduit that will direct the displaced water, under pressure, towards the electrical generator, which, as mentioned, includes a turbine or other power generation device.

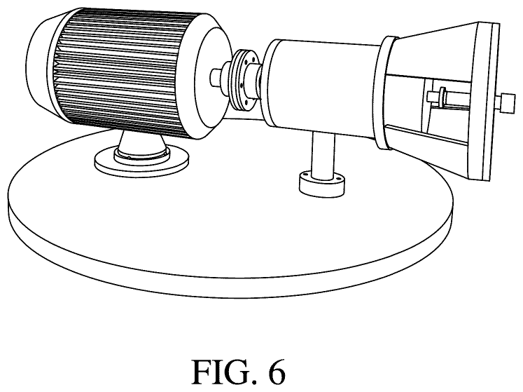

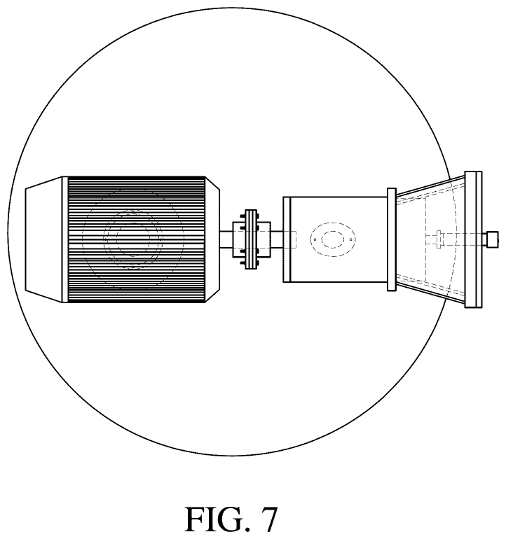

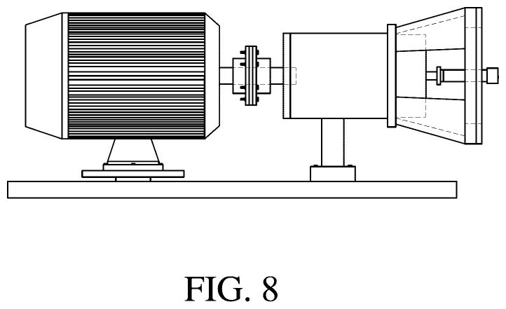

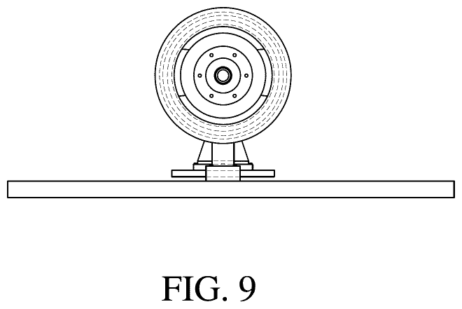

Examples of a power generation device or generator are shown in FIGS. 6-9. However, as noted, this should not be limiting and should be considered to be generally any power generating device.

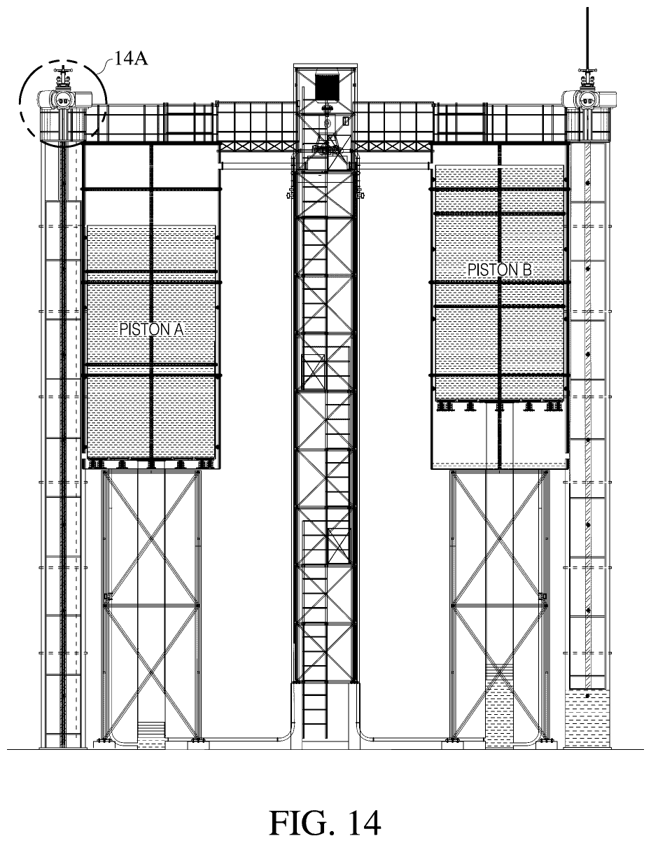

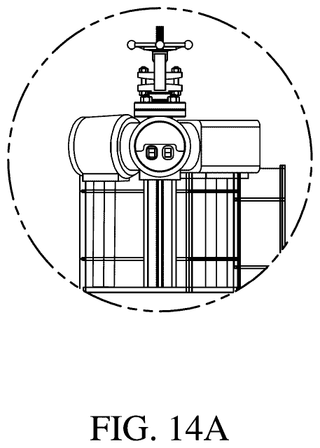

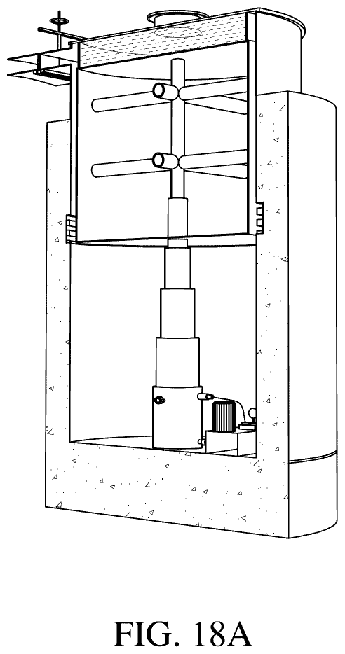

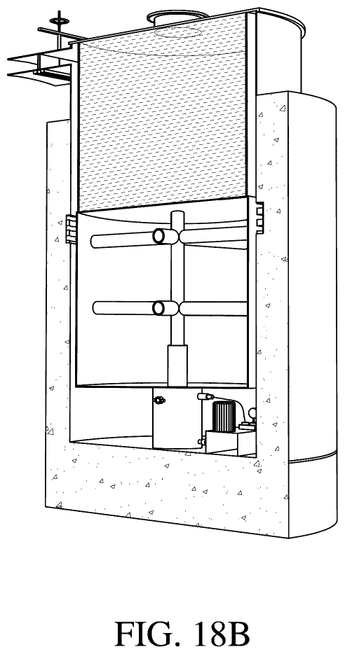

After passing through the power generation device, the water can be directed, via a penstock, towards a displacement system that is positioned adjacent the tower. The displacement system includes a reservoir and pumping mechanism to hold and move water for the power generation system, which is referred herein as a Volume Displacer. For example, the motorized hydraulic cylinder press pumping mechanism as shown in FIGS. 18A-18B can be used to move water from the reservoir of the displacement system into the tower area known as the Main Piston Housing. This is also shown generally in the left hand side of FIG. 14 and 14A, where a motorized geared screw press pumping mechanism is utilized. The water will collect around the Main Piston Housing and the buoyancy will cause the Convertible Liquid Ladened Piston to be raised into a potential energy position where water or other liquids can be trapped by closing its central doors and moving downward again to repeat the cycle of displacing the water beneath the CLLP plate in the bottom of the Main Piston Housing to direct it towards the common generator.

Friction between the pistons and the walls of the housing can be reduced, such as via the use of rollers. Inflatable or non-inflatable seals (e.g., O-rings) can be used in the tower housings to mitigate water being displaced in unwanted directions and to encourage the water movement in the system towards the generators.

Additional improvements and/or advantages of such a system as shown and/or described include but are not limited to remarkably reduced depth or vertical height, which saves shaft sinking cost by over 75% and save shaft sinking time by 60%, thus enabling rapid deployment of the technology across the world. There is elimination of conventional pumping to regenerate the piston, which saves time and energy for pumping of water out of the ballast tanks. The challenge of procurement of high head and high discharge submersible pump is lessened. The system ensures very high effective head is abundantly available for power generation.

The power generation system disclosed has lower area footprint per kilowatt than the previous versions, because depth or vertical height is greatly reduced while using increased shaft diameter to compensate for the reservoir volume which ensure higher head for higher power generation.

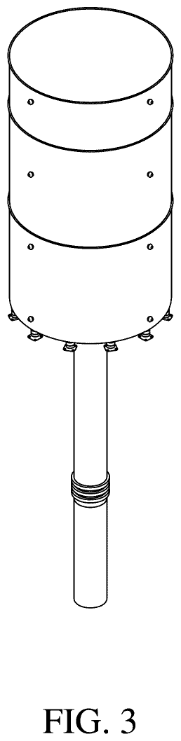

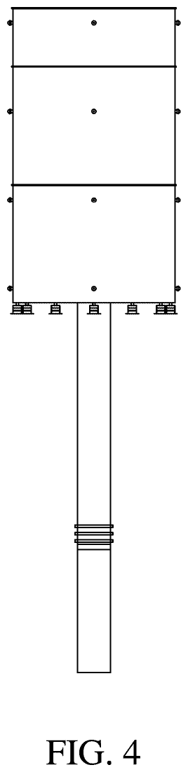

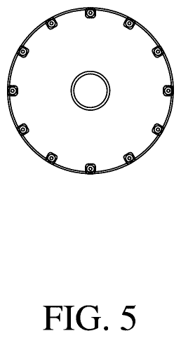

The pistons, as shown in FIGS. 3-5, include a plunger portion at the CLLP and a piston rod-shaped portion extending therefrom. The plunger portion includes a hollow portion that acts as a water or other liquids collector. The piston rod shaped portion is a primary fixed air tank of the CLLP with calculated volume of air that creates more than enough buoyancy to enable it float rapidly when fully submerged in the water or other liquids following the operation of the Volume Displacer. The tanks may be made of stainless steel or any other material with sufficient mechanical strength.

For example, the ballasts may be the same or similar to the ballasts which are shown and described in U.S. Pat. No. 10,801,476 (the '476 patent), hereby incorporated by reference in its entirety. This includes the manners provided for opening and closing such ballasts to change the weight and/or buoyancy of the components. However, one improvement is that the ballast(s) in the present disclosure is a fixed volume and what alters the buoyancy of the Convertible Liquid Containing Piston is the Operation of the Volume Displacer. One difference is that in the '476 patent the Convertible Piston descends fully submerged in water whereas, in the present disclosure, the Convertible Piston descends with only the plunger portion of the Convertible Piston submerged while the other portion is descending in air. This is made possible by the innovative Volume Displacer that receives substantially all of the water not trapped by closing the piston doors into its reservoir and returning the same back to the Main Piston Housing when the Convertible Piston is nearing point of zero potential energy. The Volume Displacer refloods the Main Piston Housing with water or other liquids which enables upthrust to kick in and causes the Convertible Piston to ascend. In addition, as noted in the '476 patent, the convertible piston was weighted with hematite or other weighted solids to create a pressure difference for fluid to flow through the penstock to the power generators, whereas in this present disclosure the Convertible piston does not need an additional solid weighted material to function effectively.

Still further, the use of inflatable seals was prominent in the embodiments of the '476 patent, however, in this present disclosure, the use of special maintenance free polymer seals is recommended which has lifespan exceeding 50 years.

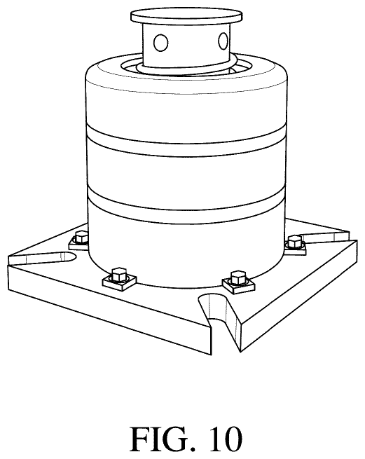

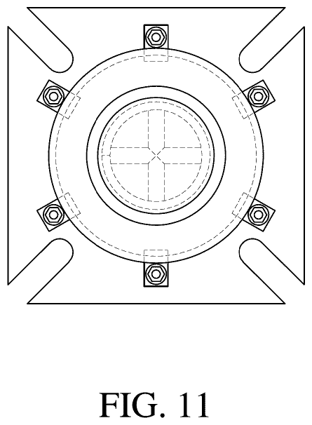

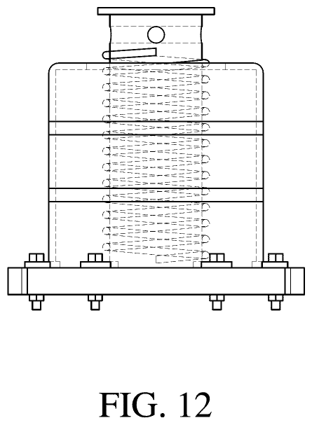

FIGS. 10-19 show yet additional components of the system. The figures show spring loaded leg members, that are positioned on the underside of the tanks of the pistons. These legs reduce the impact of the piston when it is lowered under gravity (e.g., when water has been introduced to the convertible ballasts to overcome the buoyancy of the pistons). The spring-loaded pads can also be affixed to the bottom of the Main Piston Housing to serve the same purpose. The legs will contact surfaces in the housings, and the springs will reduce the impact to improve on the longevity of the system.

At the upper part also, there are spring loaded piston stoppers to limit the rising of the piston beyond the designed set point.

On top of the central walkway above the main piston is the Hydraulic Tank and pumping system connected by flexible helical pressure hose to the double acting hydraulic cylinder mechanism that opens and closes the piston central doors.

Included are some technical aspects of an example system. It should be noted that these are for descriptive purposes and are not to be limiting on the present disclosure, but to provide additional support and/or examples for such disclosures.

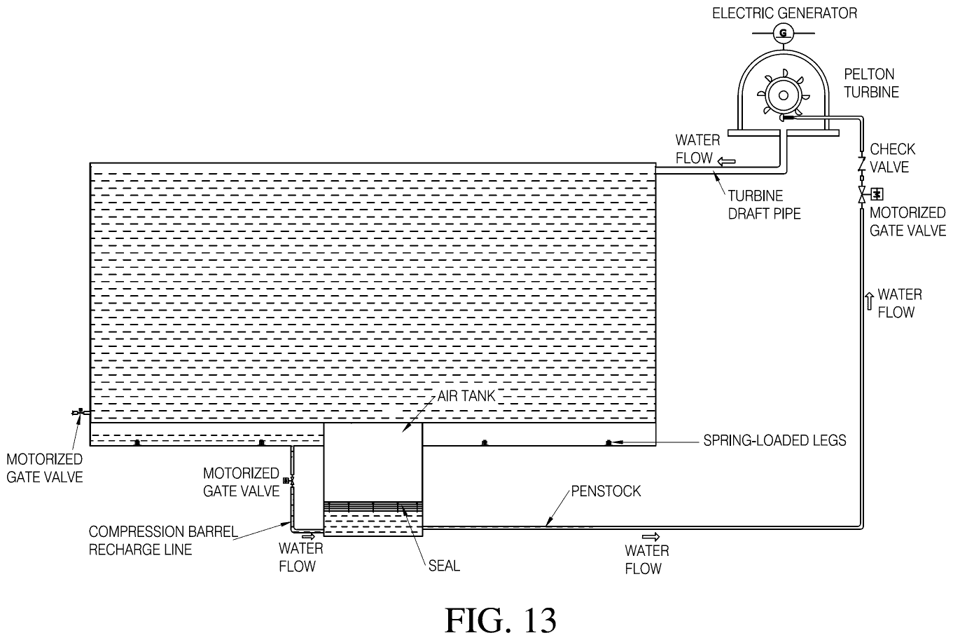

Typical size specifications for automated hydraulic hydropower system and power generation calculations based on the schematic diagram in FIG. 13, given:

$$Density of water = 1000 kg / m \hat{} 3 \\ Acceleration due to gravity = 9.81 m / s \hat{} 2 \\ Constant pie π = 3.142$$

Main Piston Housing inner diameter of 100.1 m
Main Piston Housing height of 50 m
Cylindrical Stainless Steel Piston tank/shaft inner diameter=100 m
Cylindrical Stainless Steel Piston tank/shaft height h=45 m
Cylindrical Stainless Steel Piston tank/shaft shell thickness t₁=0.016 m
Cylindrical Stainless Steel Piston tank/shaft base plate thickness t₂=0.018 m
Cylindrical Stainless Steel Piston Air tank/plunger outer diameter=17.36 m
Cylindrical Stainless Steel Piston Air tank/plunger height h=14 m
Cylindrical Stainless Steel Piston Air tank/plunger end plate thickness t₃=0.035 m
Cylindrical Stainless Steel Piston Air tank/plunger piston Plate thickness t₄=0.050 m
Cylindrical Stainless Steel Piston Air tank/plunger Piston Plate diameter=17.422 m
Cylindrical Stainless Steel Main Piston Housing Piston plunger inner diameter=17.424 m

Piston seals and lock nuts and bolts weight are negligible and the entire Convertible Liquid Ladened Piston is made of the same quality of stainless steel with a density of 8000 kg/m\hat{ }3

Air is in a rigid Piston Air tank at atmospheric pressure

No heat is applied except heat due to sealing friction which is negligible.

Five sets of Volume Displacers (Motorized Geared Screw Press Type) 10,000,000N pressing force each are installed per piston unit, each driven by a 1000 Kw and operate for 20 seconds per piston cycle.
Volume Displacer Volume given as 23,957.75 m\hat{ }3
10 units of Motorized Hydraulic Cylinder Door Opener/Closer driven by 1 kw DC Motor each. are installed per piston and operate at full load for 20 seconds per piston cycle.

Total surface area of the CLLP doors is three quarters of the total surface area of the bottom of the piston main tank.

Power consumed by all other electrically operated control panel/instruments/electronic devices is given as 100 kw.

Thus, Volume V₁ of Cylindrical Stainless Steel Convertible Liquid Ladened Piston tank/shaft shell=Volume of outer cylinder−Volume of inner cylinder

V₁=π*rₒ\hat{ }2h−π*rᵢ\hat{ }2h (Where, rₒ and rᵢ are outer radius and inner radius respectively)=(3.142*50.016*50.016*45) m\hat{ }3−(3.142*50*50*45)m\hat{ }3

$${V}_{1} = 353 , 701.26 m \hat{} 3 - 353 , 475 m \hat{} 3 = 226.26 m \hat{} 3$$

Volume V₂ of Circular Stainless Steel Piston tank/shaft bottom plate=π*r\hat{ }2*t₂

$${V}_{2} = 3.142 * 45 * 45 * 0.018 ) m \hat{} 3 = 114.5259 m \hat{} 3$$

Volume V₃ of Cylindrical Stainless Steel Piston Air tank/plunger shell and both closed ends=2*π*rₒ*h*t₃+2*π*rₒ\hat{ }2*t₃=(2*3.142*8.68*14*0.035)+(2*3.142*8.68*8.68*0.035))m\hat{ }3

$${V}_{3} = 26.727 m \hat{} 3 + 16.571 m \hat{} 4 = 43.298 m \hat{} 3$$

Volume V₄ of circular piston plate=π*rₒ\hat{ }2*t₄

$${V}_{4} = ( 3.142 * 8.711 * 8.711 * 0.05 ) m \hat{} 3 = 11.92098 m \hat{} 3$$

Total volume of Stainless Steel in Convertible Liquid Ladened Piston=V₁+V₂+V₃+V₄=(226.26+114.5259+43.298+11.92098) m\hat{ }3=396.005 m\hat{ }3

$$Density of Stainless Steel = 8000 kg / m \hat{} 3$$

Mass of empty Stainless steel Convertible Liquid Ladened Piston=density ρ*Volume

$$v = ( 8000 * 396.005 ) Kg = 3 , 168 , 040 Kg$$

Volume of water contained in Cylindrical Stainless Steel Piston tank/shaft=π*r\hat{ }2*h=(3.142*50*50*45)m\hat{ }3=353,475 m\hat{ }3

Mass of water in Cylindrical Stainless Steel Piston tank/shaft=density ρ*volume v=(1000*353475)Kg=353,475,000 Kg

Total mass of Cylindrical Stainless Steel Convertible Liquid Ladened Piston tank/shaft filled with water=Mass of Cylindrical Stainless Steel Convertible Liquid Ladened Piston shell/frame+Mass of water contained in Cylindrical Stainless Steel Convertible Liquid Ladened Piston tank/shaft=3,168,040 Kg+353,475,000 Kg=356,643,040 Kg

Cylindrical Stainless Steel Convertible Liquid Ladened Piston compression plate radius=8.711 m

Cylindrical Stainless Steel Piston compression plate Area=π*r\hat{ }2=(3.142*8.711*8.711)m\hat{ }=2=238.419 m\hat{ }2

Weight force of Cylindrical Stainless Steel Piston tank/shaft containing water=m*g=(356,643,040*9.81)N=3,498,668,222 Newtons

From Pascal Law, Hydraulic Pressure at Bottom of Piston Plate=Weight Force/Area of Piston Plate=(3,498,668,222/238.419)N/m\hat{ }2=14,674,452.21 N/m\hat{ }2

Converting Pressure in N/m\hat{ }2 to meters of water head=(14,674,452.21/9810) meters of water head=1,495.866 meters of water head

Therefore, the theoretical operating Hydraulic head of the Automated Hydraulic Hydropower System illustrated in schematic diagram in FIG. 13=1,495.866 meters of water head.

Piston vertical displacement=3.05 m

Piston cycle time=90 seconds

Note: This means the piston takes 90 seconds to descend 3.05 m from a reference position.

$$Pelton Turbine efficiency = 95 \% \\ Theoretical Operating flow rate = 8000 kg / s = 8 m \hat{} 3 / s$$

Note that the flow rate is controlled by the use of motorized flow control valves.

The basic equation to calculate hydropower (the power generated by flowing water) is given by: P=η*ρ*g*h*Q, where P=Power (in watts, W), η=Efficiency of the system (dimensionless, typically a value between 0 and 1), ρ=Density of water (approximately 1000 kg/m\hat{ }3 for fresh water), g=Gravitational acceleration, h=Height of the water fall or head (in meters, m), and Q=Flow rate (volume of water flowing per second, in cubic meters per second,).

### Explanation of the Terms

Hydraulic head (h): The pressure exerted by the piston plate on water beneath it as the cylindrical piston descends by 3.05 m in 90 seconds, which convert its potential energy to kinetic energy of the pressurized water beneath the piston which moves through the penstock to the common power generation system typically a Pelton turbine or other turbines.

Flow rate (Q): The volume of water passing through the turbine per unit time, which determines the kinetic energy.

Efficiency (η): The percentage of the available waterpower that the system can convert to electricity.

This equation provides an estimate of the theoretical power output, but in practice, losses (due to friction, mechanical inefficiencies, etc.) reduce the actual generated power.

Therefore,

$$Hydropower = water density \times flow rate \times head \times acceleration due to gravity \times efficiency \\ Hydropower = ( 1000 \times 8 \times 1 , 495.866 \times 9.81 \times 0.95 ) watt \\ Hydropower = 111 , 525 , 785.5 watt = 111.525785 MW$$

A verification of hydropower generation potential based on Gravitational Potential Energy Equation: PE=W=mgh

Where PE is potential energy, W is the work done, m is the mass of the object, g is the acceleration due to gravity, and h is the height from which the object falls.

This formula gives the work done if the object falls through a distance h under the influence of gravity without any other forces like air resistance acting significantly.

Recall from specifications highlighted previously in FIG. 13, wherein the total mass of Cylindrical Stainless Steel Convertible Liquid Ladened Piston tank/shaft filled with water=356,643,040 Kg.

Acceleration due to gravity=9.81 m/s\hat{ }2

Piston vertical displacement is 3.05 m, thus reference height is 3.05 m

Piston cycle time of 90 seconds which implies that the piston takes 90 seconds to fall through the reference height of 3.05 m.

Therefore,

$$Potential energy = mass \times acceleration due to gravity \times height = ( 356 , 643 , 040 \times 9.81 \times 3.05 ) Joules = 10 , 670 , 938 , 78.32 Joules$$

Convert Joules to power in watts when 1 watt=1 Joule per second and the piston lapse time during power generation stroke is 90 seconds.

$$Power = Energy / Time = ( 10 , 670 , 938 , 78.32 / 90 ) W = 118 , 565 , 978.65 W \\ Converting to Megawatt = ( 118 , 565 , 978.65 / 1000000 ) W = 118.565978 MW$$

The Gravitational Potential Energy of the typical specification shown in FIG. 13 is equivalent to 118.565978 MW.

In addition, the Kinetic Energy of the pressurized water stream can also be calculated as follows:

$$K E = 1 / 2 {mv}^{⋀} 2$$

Where KE is kinetic energy, m is the mass (flow rate), and V is the velocity of the pressurized stream.

The typical velocity of a water jet in a high pressure nozzle for a turbine (such as Pelton turbine or impulse turbine) as shown in FIG. 13 depends on the available water head and the pressure of the system and can be calculated using the formula:

V=√2gH

Where, V is velocity of water jet in m/s, g is acceleration due to gravity (9.81 m/s\hat{ }2), and H is effective water head in meters, which indicates:

$$V = √ 2 gh = √ ( 2 ⋆ 9.81 ⋆ 1495.866 ) m / s = √ ( 29 , 34 \; 8.8 \; 909 ) m = 171.315 m / s$$

$$Recall , KE = 1 / 2 {mv}^{⋀} 2$$

$$Mass flow rate = Volumetric flow rate ⋆ density$$

$$Mass flow rate = ( 8 ⋆ 1000 ) kg / s = 8000 kg / s$$

$$KE = ( 1 / 2 ⋆ 8000 ⋆ 171.315 ⋆ 171. 3 \; 15 ) Joules = 117 , 395 , 316.9 Joules$$

Converting Energy in joules to watt

$$Power in watt = Energy / Time in seconds$$

$$Power in watt = ( 117 , 395 , 31 6.9 / 1 ) watt = 117 , 395 , 316.9 watt = 117.3953169 MW$$

The energy conservation deductions are as follows:

From the above theoretical power output calculations, the gravitational potential energy of the Cylindrical Stainless Steel Convertible Liquid Ladened Piston tank/shaft containing water (source of potential energy) is equivalent to 118.565978 MW and the Theoretical Kinetic Energy is equivalent to 117.3953169 MW. The difference of 1.1706611 MW is energy losses due to friction and mechanical inefficiencies, whereas, the calculated Theoretical Hydropower Output of the same power generation system is 111.525785 MW, which is less than the gravitational potential energy at the source by 7.040193 MW, meaning that energy is not created within the system.

Also, because no energy conversion system can attain 100% efficiency, the output of the power generation system must be less than the source of gravitational potential energy, therein the Cylindrical Stainless Steel Piston tank/shaft containing water.

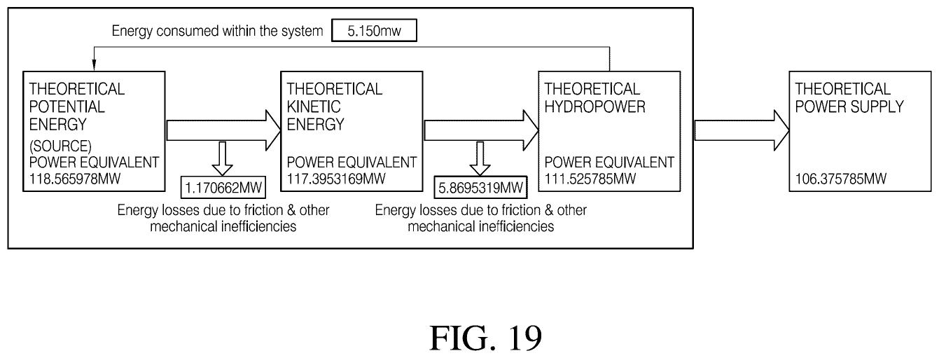

The differences are further attributed to exergy losses due to friction, sounds, mechanical and electrical inefficiencies, and other irreversible losses to the surrounding of the power generation system. See, e.g., FIG. 19 for a schematic diagram of the energy conversion within the Automated Hydraulic Hydropower System (AHHS).

Therefore, energy is conserved, energy is neither created nor destroyed but converted from one form to another within the Automated Hydraulic Hydropower System (AHHS).

Net energy generation gain per piston full cycle calculations:

Net energy generation gain per piston full cycle in typical Automated Hydraulic Hydropower System (AHHS) as shown in FIG. 13 can be calculated by first determining the energy generated per piston cycle and then subtracting the energy consumed per piston cycle.

Calculations of energy consumption during Piston regeneration phase are as follows:

As soon as the Piston moves down to the set point of substantially zero power generation, the volume displacer empties the water it earlier received back to the Main Piston Housing and the piston is substantially submerged.

Once the central doors of the Convertible Piston Containing Liquid CPCL are open and the Valve on the Piston Plunger Barrel Recharge Line is also open, the ballasts of the piston are opened the buoyant forces surpass the weight of the piston and cause it to rise very fast to the set point of maximum potential energy.

From Archimedes principle, the buoyant force exerted on an air volume submerged underwater is calculated using Archimedes' principle, which states that the buoyant force is equal to the weight of the displaced fluid. In the case of an air volume submerged in water, the buoyant force is equal to the weight of the water displaced by the air volume.

Formula for Buoyant Force: F_{b=ρwater*}V_{air*}g

where:
F_{b} is the buoyant force (in newtons),
ρ_{water} is the density of water (approximately 1000 kg/m\hat{ }3 for fresh water),
Vₐᵢᵣ is the volume of air submerged (in cubic meters), and
g is the acceleration due to gravity (approximately 9.82 m/s\hat{ }2)

Typical calculations based on dimensions specified in FIG. 13:

The fixed piston air tank volume=π*r\hat{ }2*h=(3.142*8.711*8.711*14) m\hat{ }3=3,337.876 m\hat{ }3

Piston air tank volume of 3,337.876 m\hat{ }3 is submerged in fresh water:

So, the upward buoyant force F_{b} exerted on a fixed volume of air 3,337.876 m\hat{ }3 contained in the submerged piston air tank is calculated as follows:

$${F}_{b} = ( 1000 ⋆ 3 , 337.876 ⋆ 9.81 ) N = 32 , 744 , 563.56 N$$

### Recall

Mass of empty Stainless steel Convertible Liquid Ladened Piston=3,168,040 Kg

Weight force F_{w} acting downward due to this mass of the piston tank/shaft frame=m*g

$${F}_{w} = ( 3 , 168 , 040 ⋆ 9.81 ) N = 31 , 078 , 472.4 N$$

The difference between the upward buoyant force F_{b} and downward weight force F_{w}=(32,744,563.56−31,078,472.4) N=1,666,091.11N

Therefore, the piston moves upward very fast and with an excess of 1,666,091.11N. The piston can effectively overcome other downward forces acting on the piston as it rises to the set point of maximum potential energy for the cycle to repeat.

### Important Considerations

The buoyant force only depends on the volume of air submerged and the density of the water, not on the weight of the air.

The weight of the air is negligible compared to the buoyant force, since air is much less dense than water.

Alternatively,

Mass of empty Stainless steel Convertible Liquid Ladened Piston=3,168,040 Kg

Coverting mass in kg to ton=3,168,040 Kg/1000=3,168.04 ton

Theoretically, 1 m\hat{ }3 of Air under water would lift 1000 kg or a ton of object fully submerged in water.

Hence, 3,337.876m\hat{ }3 of air in the air tank will lift a 3,168.04 ton piston and still has excess upthrust to lift an additional 169.83 ton of object submerged under water.

Therefore, in the light of the calculations above, it is obvious that the Convertible Liquid Containing Piston CLCP only relies on buoyant forces from the fixed volume of air in the piston air tank to rise back to the set position of maximum potential energy for continuous power generation cycle.

The Gravitational Potential Energy of the typical specification shown in FIG. 13 is equivalent to 118.5659 MW per piston cycle.

The theoretical Hydropower generated in a typical specification shown in FIG. 13 is =111,525,785.5 watt

Theoretical Hydropower=111.525785 MW

### Power Consumption Calculations

Power consumed by the volume displacer:

The volume displaced V_{d} by Volume Displacer is =π*r\hat{ }2*h

$${V}_{d} = ( 3.142 ⋆ 50 ⋆ 50 ⋆ 3.05 ) {m}^{⋀} 3$$

Volume displaced out and into the Main Piston Housing=23,957.75 m\hat{ }3

From Archimedes principle, the buoyant force exerted on an air volume submerged underwater is calculated using Archimedes' principle, which states that the buoyant force is equal to the weight of the displaced fluid. In the case of an air volume submerged in water, the buoyant force is equal to the weight of the water displaced by the air volume. Formula for Buoyant Force: F_{b}=ρ_{water*}V_{air*}g

Buoyant Force to be overcome by Volume Displacer=(1000*23,957.75*9.81)N=235,025,528N

### Given

Five set of Volume Displacers installed per piston unit, each driven by a 1000 kw rated Direct Current (DC) motor must be operated to overcome the total force of 235.025,528N in 20 seconds, being the time taken for the volume displacement to occur per piston cycle. This means that each Volume Displacer has a maximum installed capacity of 5,000 m\hat{ }3.

The Volume Displacer functions with either a motorized geared screw press or motorized hydraulic press mechanisms but is not limited to these two mechanisms.

To calculate the power consumption of a motorized gear press for instance the following parameters are considered, including the motor's power rating, the operating time, and load efficiency.

### Identify Motor Specifications

Motor Power Rating (P): The rated power of the motor in kilowatts (kW) or horsepower (HP). 1 HP=0.746 kW. In this case it is given as 1000 kw for each of the five displacer units. The type is Brushless Direct Current Motor (BLDCM)

Efficiency (η): The efficiency of the motor as a percentage. This value is typically provided by the motor manufacturer and helps account for energy losses due to heat, friction, etc. In this case it is given as 95%.

### Determine the Load

Load (τ): The torque required to press (measured in Nm or lb-ft).

Operating Speed (ω): The speed of the motor (usually in RPM, or it can be converted to rad/sec). In this case the Motor has a rotational speed of 1500 RPM.

The load for each unit of the Volume Displacers is approximately 47,005,105.6N derived from the division of the total Buoyant Force to be displaced by a factor of 5 representing the 5 units of the Volume Displacers (235,025,528N/5). To overcome this load the rated pressing force must be higher than load hence, the motorized geared screw press has a combined rating of 50,000,000N.

### Mechanical Power (Pm)

Calculated using the formula: Pm=τ*ω/9550 (for Nm and RPM)

Here is the step-by-step calculation approach:
1. Motor Torque

First, calculate the torque output from the motor.

$$Tmotor = Pinput / ω$$

Where:
Tmotor is the motor torque in Newton-meters (Nm).
Pinput is the input motor power in kilowatts (kW).
ω is the angular velocity of the motor in radians per second
The angular velocity ω can be calculated from the motor's rotational speed in RPM(N) using the formula:

$$ω = 2 π n / 60$$

Where,

N is the motor speed in revolutions per minute (RPM) and is given as 1500 RPM

$$ω = 2 π N / 60 = ( 2 ⋆ 3.142 ⋆ 1500 ) 60 = 157.1 radians / second$$

From

$$Tmotor = Pinput / ω$$

$$Tmotor = ( 10 \; 00 \; 000 / 157.1 ) Nm = 6 , 365.37 Nm$$

2. Torque After Gear Reduction

The motor drives the press through a gear system, and the gear reduction ratio R is given as 8:1 which means the gear will increase the torque at the screw shaft by 8 times.

The output torque after the gear reduction is:

$$Toutout = T ∖ times R$$

Where R is the gear reduction ratio.

$$Toutput = Tscrew = ( 6 , 365.37 ⋆ 8 ) Nm = 50 , 9222.96 Nm$$

Pressing force or axial force on the Screw Press is calculated as follows:

The pressing force depends on the screw pitch Pscrew, which is the distance the screw advances per revolution and in this case is given as 0.006 m.

Given also the mechanical efficiency of the ball screw as 95%.

Pressing force F can be calculated using:

$$F = ( 2 π ⋆ {Toutput}^{⋆ η} ) / Pscrew$$

Where:
F is the pressing force in Newtons (N).
Toutput is the torque at the screw (Nm).
η is the mechanical efficiency of the screw.
Pscrew is the pitch of the screw, i.e., the distance the screw advances per revolution (in meters or millimeters).

$$F = ( ( 2 ⋆ 3.142 ⋆ 50 , 922.96 ⋆ 0.95 ) / 0.006 ) N = 50 , 666 , 647.77 N$$

The pressing force for each of the screw press is 50,666,647.7N

Total Press force for the five units of volume displacers=(5*50,666,647,7) N=253,333,238.8N

### Calculate Power Consumption

Using the formula:

$${P}_{c o n s u med} = {P}_{m} / η$$

Where P_{consumed} is in kW.

The 5 DC Motors Rated 1000 KW each on full load will consume (5*1000) KW=5000 KW

For total energy consumption (in kilowatt-hours), multiply the power consumption by the time t the motor is running:

$$E = {P}_{consumed} * t$$

Where E is in kilowatt-hours (kWh) and t is the operating time in hours.

Given five (5) gear press driven by 1000 KW rated DC motors each operating at 95% efficiency and running for 20 seconds per piston cycle of 90 seconds.

Note that the DC motors runs for 20 seconds per cycle,

Covert seconds to hour

$$20 seconds = 0.00555 hours$$

$$Motor Efficiency : η = 95 \% = 0.95$$

$$Power Consumption = Power Rating * Motor efficiency * Time in Hour = 1000000 * 0.95 * 0.00555 = 5.2777 kw - hour$$

Total Power consumption by the 5 DC motors=5*5.2777 Kw-hour=26.388 Kw-Hour

Power consumed by Convertible Liquid Ladened Piston Central Doors Opener and Closer Mechanism (motorized double acting hydraulic cylinder) is calculated as follows:

To determine the Hydrostatic Pressure acting on the bottom of the Convertible Liquid Ladened Piston submerged in Main Piston Housing at 50 meters depth, the following formula is applied:

$$P = F / A$$

Where

$$P = Pressure at bottom N / m \hat{} 2$$

$$F = force = mg$$

$$m = density * volume ( volume of cylinder = π r \hat{} 2 h ) = ( 3.142 * 50 * 50 * 45 ) m \hat{} 3 = 353475 m \hat{} 3$$

$$m = 1000 * 353 , 475 Kg = 353 , 475 , 000 kg$$

$$F = force = mg$$

$$F = ( 353 \; 475000 * 9.81 ) N = 3 , 467 , 589 , 750 N$$

Area of the bottom of the Convertible Liquid Ladened Piston=πr\hat{ }2=(3.142*50*50)m\hat{ }2

$$A = 7855 m \hat{} 2$$

$$P = F / A = ( 3 , 467 , 589 , 750 / 7855 ) N / m \hat{} 2 = 441 , 450 N / m \hat{} 2$$

To calculate the force needed to open inwardly or close outwardly the Convertible Liquid Ladened Piston central doors located at the bottom of the fully submerged piston at a depth of 50 meters under water in the Main Piston Housing, we need to consider the pressure difference between the water outside the doors and the water inside the piston the cylinder.

### Steps to Calculate the Force

Calculate the Water Pressure at the Depth of 50 meters:

The pressure exerted by the water at a depth is given by the formula:

P=ρgh

Where:
P=Pressure at a depth of 50 meters (in Pascals, Pa)
ρ=Density of water (approximately 1000 kg/m\hat{ }2 for freshwater)
g=Gravitational acceleration 9.81m/s\hat{ }2
h=Depth of the water column Main Piston Housing which is 50 meters see FIG. 13.

$$P = ρ gh = ( 1000 * 9.81 * 50 ) Pa = 490 , 500 Pa$$

### Determine the Pressure Difference

The pressure inside of the cylinder is typically approximately at the same pressure outside, because the piston bottom plate and doors thickness is within 0.035 m.

The pressure difference is the difference between the water pressure at 50 meters and the internal pressure of the piston cylinder at the same depth of 50 meters.

Pressure Difference=0

Calculate the Area of the: CLLP doors

Given by design that the total surface area of the CLLP doors is three quarters of the total surface area of the bottom of the piston.

$$Total Surface Area of CLLP doors is = ( 3 / 4 * π r \hat{} 2 ) m \hat{} 2 = ( 0.75 * 3.142 * 50 * 50 ) m \hat{} 2 = 5 , 891.25 m \hat{} 2$$

### Calculate the Force

The force required to open the CLLP doors is the pressure difference multiplied by the area of the CLLP doors=(0*5891.25) N=0

When a cylinder is fully filled with water, the water inside exerts pressure equal to the water outside at the same depth. Therefore, the pressure difference across the CLLP doors is negligible, meaning only a minimal force (like the friction or mechanical resistance of the door cover) is required to open it.

### Key Assumptions

1. The pressure inside the cylinder at the bottom is equal to the external pressure at the same depth because the cylinder is filled with water.
2. Any pressure difference due to slight variations in the internal and external water levels is negligible.
3. For an inward-opening or outward closing of manhole at the bottom of a submerged, water-filled cylinder, the force required is very small, since the water pressure inside and outside the cylinder at the same depth cancels out. The exact force would depend on the mechanical design of the CLLP doors and any sealing or friction, but the force due to pressure difference is effectively zero.
4. Given

10 units of Motorized Hydraulic Cylinder Door Opener/Closer driven by 1 kw DC Motor operating at full load for 20 seconds per piston cycle.

Power consumed per second by 10 units of motor rated at 5 kw at full load=(10×5) kw=50 kw

For total energy consumption (in kilowatt-hours), multiply the power consumption by the time t the motor is running:

$$E = {P}_{consumed} * t$$

Where E is in kilowatt-hours (kWh) and t is the operating time in hours.

Given five (10) 5 KW rated DC motors each operating at 95% efficiency and run for 20 seconds per piston cycle of 90 seconds.

Note that the DC motors runs for 20 seconds per cycle,

Covert seconds to hour

20 seconds=0.00555 hours

Motor Efficiency: η=95%=0.95

Power Consumption=Power Rating*Motor efficiency*Time in Hour=50*0.95*0.00555=0.263625 kw-hour

Total Power consumption by the 10 number of 5 kw DC motors per piston cycle=0.263625 Kw-hour

### Recall

Power consumed by all other control panels and control instruments and electronic devices is given as 100 KW

Total power consumed per typical piston cycle as shown in FIG. 13 is calculated as follows:
Power consumed by Volume Displacer Unit+Power consumed by Convertible Liquid Ladened Piston central doors opener and closer mechanism+Power consumed by all other electrically operated control panel/instruments/electronic devices.

$$= ( 5000 + 50 + 1 \; 00 ) Kw = 5 , 150 kw = 5.15 MW$$

Net Power Per Piston Cycle of 90 seconds

$$= Power generated per piston cycle - power consumed per piston cycle to continuously operate the system = 111.525785 MW - 5.150 MW = 106.375785 MW$$

Therefore

$$Net Power = 106.375785 MW$$

$$\% of generated power consumed = ( Power consumed / Total power generated ) \times 100$$

$$\% of generated power consumed = ( 5.15 / 111.525785 ) \times 100 = 4.6 \%$$

Net Energy=energy generated per piston cycle−energy consumed per piston cycle to continuously operate the system

Convert Power to Energy in Joules=Power×Time

$$Net Energy = ( 111 , 525 , 785 * 90 ) - ( 5 , 150 , 000 * 90 )$$

$$Net Energy = ( 10 , 037 , 320 , 650 - 463 , 500 , 000 ) Joules = 9 , 573 , 820 , 650 Joules$$

$$Net Energy Gain Ratio = 10 , 037 , 320 , 650 J / 463 , 500 , 000 J = 21.655$$

From Net Energy Gain (NEG) Concept: When, ratio of energy produced (J_{P}) to energy required (J_{R}) is greater than one, the energy facility has a positive net energy and when it is less than one, the energy facility has a negative net energy.

$$NEG = {J}_{P} / {J}_{R} > 1 ( power net energy )$$

Since 21.655 is greater than 1, NEG IS POSITIVE

Therefore, Automated Hydraulic Hydropower System (AHHS) has a typical NEG per piston cycle of 21.655.

This record-breaking NEG ratio means that every one unit of electrical power input gives an output of 21.655 unit of electrical power.

The deeper the cylindrical piston shaft, the higher this NEG ratio.

The most innovative aspect is in the design of the Convertible Liquid Ladened Piston and the Volume Displacer, which gives Automated Hydraulic Hydropower System (AHHS) capability to convert the great weight of water ladened in the Convertible Liquid Ladened Piston and the entire solid weight of the Convertible Liquid Ladened Piston to do useful work while the piston frame weight is relatively very small in comparison to the weight of the water contained in the Convertible Liquid Ladened Piston and can easily be lifted by buoyant forces from bottom to top of the piston housing by a fixed volume of air in the piston air tank.

More so, the automated synchronization of the at least two piston units with a Common Power Generator (CPG) makes it to be true as an independent uninterrupted renewable power plant.

For a 100 MW installation with Main Piston Housing/shaft diameter as 100.1 m and Main Piston Housing/shaft depth of 50 m, an area measuring 200 m×350 m is utilized to site the plant which comes with a twin shaft and piston units for uninterrupted power generation and supply. This means an area footprint of 70,000 m\hat{ }2 per 100 MW. Therefore, for this case the Area Footprint Per Megawatt is 700 m\hat{ }2.

Note also that in another case of 300 MW system where the Main Piston Housing/shaft diameter is 100.1 m and the shaft depth is 155 m, an area measuring 200 m'350 m is required to site the plant which comes with a twin shaft and piston units for uninterrupted power generation and supply. This means an area footprint of 70,000 m\hat{ }2 per 300 MW. Therefore, for this case the Area Footprint Per Megawatt is 233.333 m\hat{ }2.

Similarly, in another case of 600 MW system where the Main Piston Housing/shaft diameter is 100.1 m and the shaft depth is 305 m, an area measuring 200 m×350 m is required to site the plant which comes with a twin shaft and piston units for uninterrupted power generation and supply. This means an area footprint of 70,000m\hat{ }2 per 600 MW. Therefore, for this case the Area Footprint Per Megawatt is 116.66 m\hat{ }2.

The area footprint depends upon the shaft depth, the deeper the shaft the lower the area footprint per Megawatt or per Kilowatt.

As noted, any of the systems provided may be controlled mechanically, but it is contemplated that the system is to be controlled by a programmable logic control (PLC). The system may also utilize any industrial control system (ICS). ICS is a general term that encompasses several types of control systems and associated instrumentation used for industrial process control. Such systems can range from a few modular panel-mounted controllers to large interconnected and interactive distributed control systems with many thousands of field connections. All systems receive data received from remote sensors measuring process variables (PVs), compare these with desired set points (SPs) and derive command functions which are used to control a process through the final control elements (FCEs), such as control valves. The larger systems are usually implemented by Supervisory Control and Data Acquisition (SCADA) systems, or distributed control systems (DCS), though SCADA and PLC systems are scalable down to small systems with few control loops. Such systems are extensively used in industries such as chemical processing, pulp and paper manufacture, power generation, oil and gas processing and telecommunications.

One or more embodiments including the PLC described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

The PLC according to the aspects of the present disclosure may also include components such as intelligent control and communication components. Examples of such intelligent control units may be central processing units alone or in tablets, telephones, handheld devices, laptops, user displays, or generally any other computing device capable of allowing input, providing options, and showing output of electronic functions. A central processing unit (CPU), also called a central processor or main processor, is the electronic circuitry within a computer that carries out the instructions of a computer program by performing the basic arithmetic, logic, controlling, and input/output (I/O) operations specified by the instructions. Still further examples include a microprocessor, a microcontroller, or another suitable programmable device and a memory. The controller also can include other components and can be implemented partially or entirely on a semiconductor (e.g., a field-programmable gate array (“FPGA”)) chip, such as a chip developed through a register transfer level (“RTL”) design process.

The memory includes, in some embodiments, a program storage area and a data storage area. The program storage area and the data storage area can include combinations of different types of memory, such as read-only memory (“ROM”, an example of non-volatile memory, meaning it does not lose data when it is not connected to a power source) or random access memory (“RAM”, an example of volatile memory, meaning it will lose its data when not connected to a power source). Some additional examples of volatile memory include static RAM (“SRAM”), dynamic RAM (“DRAM”), synchronous DRAM (“SDRAM”), etc. Additional examples of non-volatile memory include electrically erasable programmable read only memory (“EEPROM”), flash memory, a hard disk, an SD card, etc. In some embodiments, the processing unit, such as a processor, a microprocessor, or a microcontroller, is connected to the memory and executes software instructions that are capable of being stored in a RAM of the memory (e.g., during execution), a ROM of the memory (e.g., on a generally permanent basis), or another non-transitory computer readable medium such as another memory or a disc.

In order to interact or otherwise control any of the components of the system, a machine-user interface may be included. A user interface is how the user interacts with a machine. The user interface can be a digital interface, a command-line interface, a graphical user interface (“GUI”) or any other way a user can interact with a machine. For example, the user interface (“UI”) can include a combination of digital and analog input and/or output devices or any other type of UI input/output device required to achieve a desired level of control and monitoring for a device. Examples of input and/or output devices include computer mice, keyboards, touchscreens, knobs, dials, switches, buttons, etc. Input(s) received from the Ul can then be sent to a microcontroller to control operational aspects of a device.

The user interface module can include a display, which can act as an input and/or output device. More particularly, the display can be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc.

The user interface also can be configured with a microcontroller to display conditions or data associated with the main device in real-time or substantially real-time.

Therefore, aspects and/or embodiments of the present disclosure include an innovative independent electrical power generating system controlled by a programmable logic controller (PLC) that relies on the interaction of the weight of a solid (i.e., steel) and weight of a liquid (i.e., water) due to gravity, buoyant forces, proprietary volume displacer unit(s), and at least two synchronized convertible piston and cylinder units each operating in separate housings to continuously pressurize a liquid (i.e., water), which is directed in a cyclic manner by means of a penstock into or through a hydro turbine (such as a Pelton Turbine or Francis Turbine) to generate electricity for uninterrupted power supply for 24-hours per day, 7-days a week and 365 days a year. This cycle of power generation continues (not in the concept of perpetual motion), and also obeys the law of conservation of energy as energy is neither created nor destroyed within the system but converted from one form to the other as needed, to provide electrical power that can be used on-demand or otherwise stored for future use.

Thus, an automated hydropower system and components thereof is shown in FIGS. 1-19. The system comprises at least two Main Piston Housings containing a Convertible Liquid Ladened Piston each with central doors and piston plunger and a set of Volume Displacers, which are capable to convert the great weight of liquid filled in the Convertible Liquid Ladened Piston and the entire solid weight of the Convertible Liquid Ladened Piston to do useful work by exerting pressure on a liquid beneath the piston plate. The pressurized liquid is directed through a penstock to a Common Power Generator such as a Pelton Turbine to generate electricity uninterruptedly for 24 hrs per day, 7 days per week and 365 days per year, while the pressurized liquid is being recycled back to the Main Piston Housing.

The volume displacers of the system (see. e.g. FIGS. 1. 14. 14A and 18A/B) operate like a reciprocating pump and utilize either motorized geared screw press mechanism or motorized hydraulic double acting cylinder press mechanism to receive and pump out very large volumes of liquid at very short time intervals enabling the Convertible Liquid Ladened to descend under air instead of under the liquid and to ascend fully submerged in the liquid leveraging on upthrust within the system to regenerate its pistons. This enables the system to optimize its power generation capacity and net energy gain.

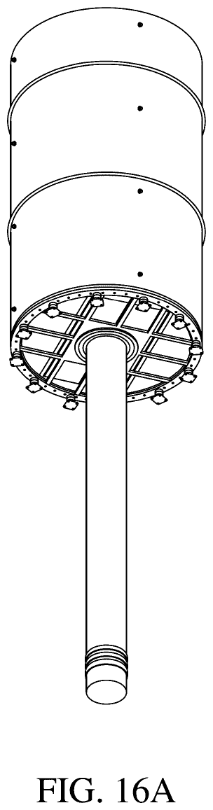

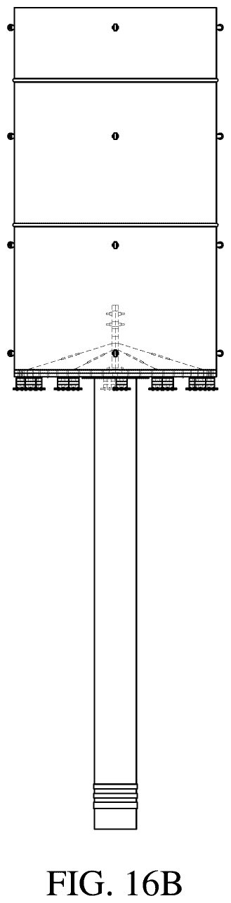

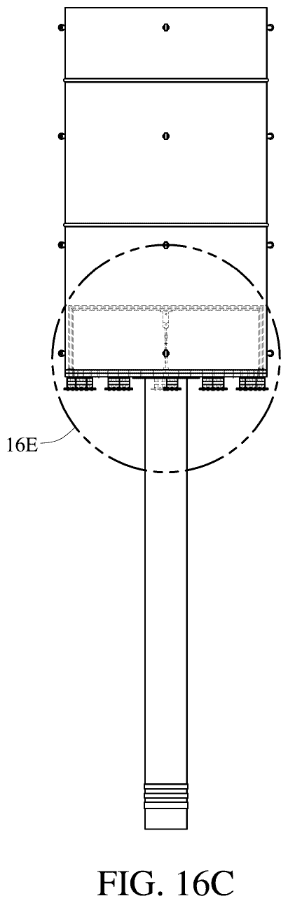

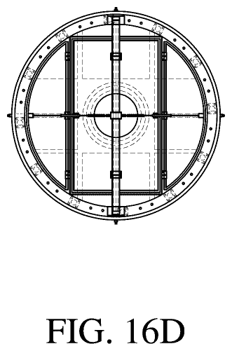

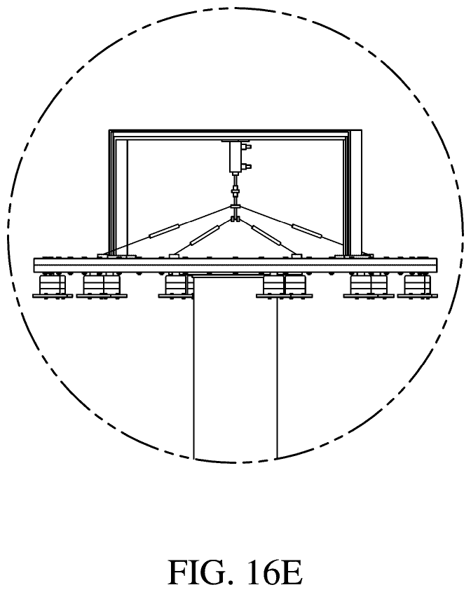

The convertible liquid ladened pistons (see, e.g., FIGS. 1 and 16A-16E) can include fixed air tanks, maintenance free seals, and piston doors that can open and close. The piston includes an open topped plunger portion and a sealed air rod-shaped extending therefrom. Rollers can be added to the outside of the plunger to aid in movement. Spring loaded legs can also be included, such as at an underside of the plunger portion.

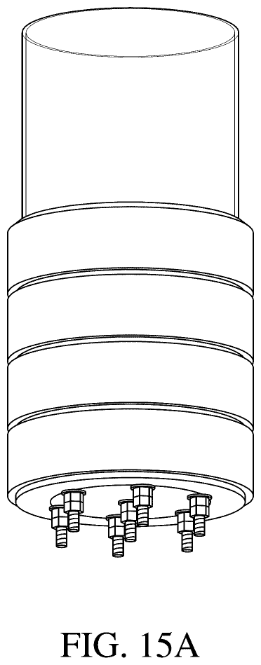

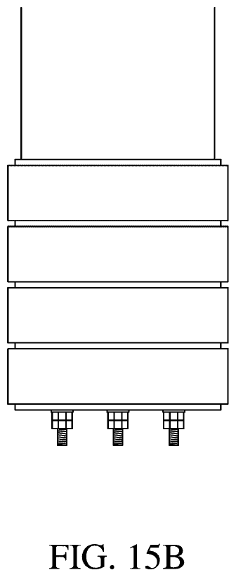

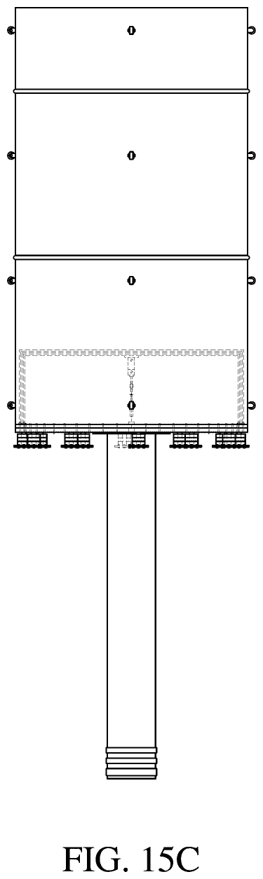

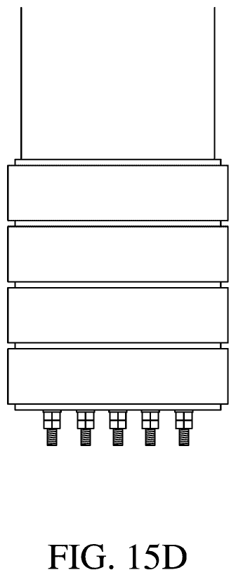

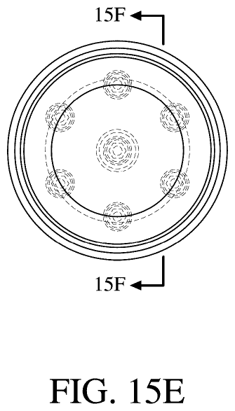

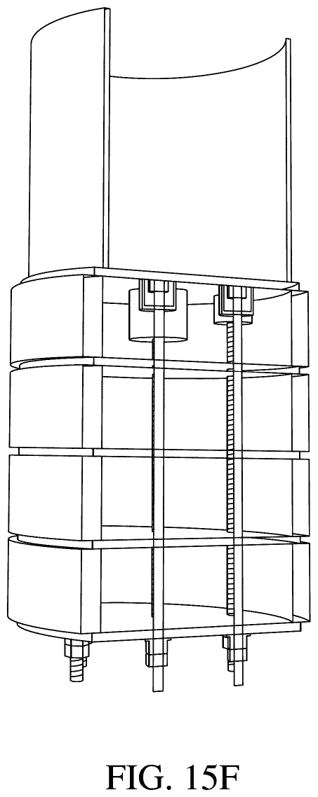

Moving to FIGS. 15A-15F, a portion of the air-sealed rod-shaped tank is shown. At a lower end, a maintenance free seal is shown. The seal mitigate the water at the bottom of the piston housing from moving upward along the rod and instead ensures that the water is displaced through the penstock and towards and through the common turbine generator (see, e.g., FIG. 13). As further shown in FIG. 13, the water, after passing through the turbine, can be added to the piston housing, where at least a portion can be directed towards the bottom in the piston rod housing portion of the housing through the compression barrel recharge line to be further displaced and directed to and through the turbine generator.

As shown in FIGS. 16A-16E, the opening/closing mechanism can include a double acting motorized hydraulic jack, a steel support for the hydraulic jack, and inlet/outlet hydraulic lines that connect to the hydraulic tank and pump situated on the walkway on top the piston housing. This will open and close the doors to allow or disallow water to pass through the underside of the piston plunger. As the upper end is open, when the door(s) is open, the water will pass through to allow the piston to move through the water. When the door(s) is closed, water is trapped within the piston increasing the weight of the piston.

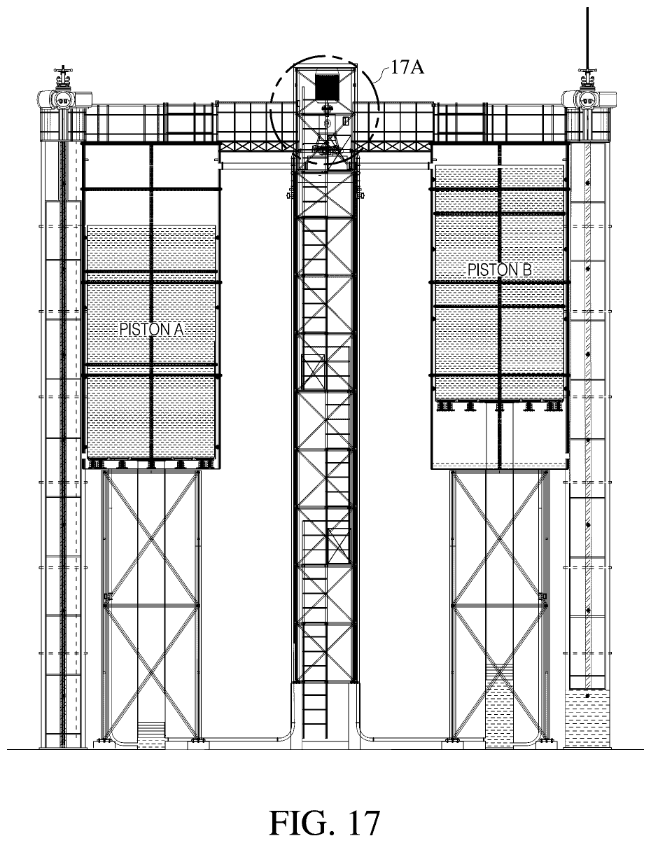

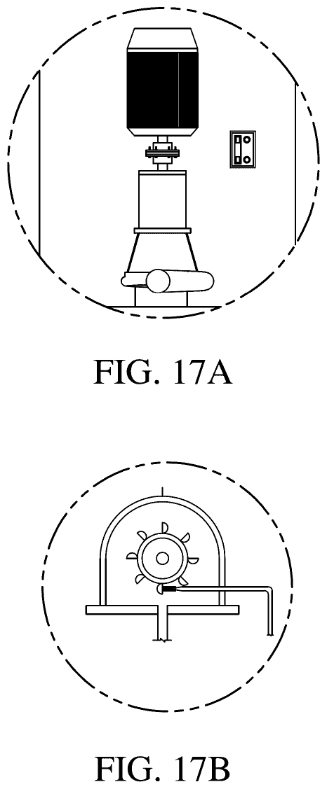

FIG. 17, 17A, and 17B shows a portion of the turbine generator, which may be a Pelton generator comprising a generator, a coupling, and a Pelton turbine. A nozzle can be positioned at the end of the penstock to increase the velocity of the water passing towards the Pelton turbine, which can increase the efficiency and general output of the generator.

As would be apparent to one of ordinary skill in the art, mechanical, procedural, or other changes may be made without departing from the spirit and scope of the invention. The scope of the invention is defined only by the appended claims, along with the full scope of equivalents to which such claims are entitled.

The present disclosure is not to be limited to the particular embodiments described herein. The following claims set forth a number of the embodiments of the present disclosure with greater particularity.

1. A power generating system, comprising:
a first piston system comprising a first piston housing comprising a plunger housing portion and a rod housing portion with a first piston movably positioned therein, the piston comprising a first piston rod extending from a first plunger and into the rod housing portion of the first piston housing;
a second piston system comprising a second piston housing comprising a plunger housing portion and a rod housing portion with a second piston movably positioned therein, the piston comprising a second piston rod extending from a second plunger and into the rod housing portion of the second piston housing;
a first volume displacer in fluid communication with the plunger housing portion of the first piston housing, wherein a fluid is selectively added and removed from the plunger housing portion of the first piston housing to selectively raise and lower the first piston;
a second volume displacer in fluid communication with the plunger housing portion of the second piston housing, wherein a fluid is selectively added and removed from the plunger housing portion of the second piston housing to selectively raise and lower the second piston; and
at least one electric generator in fluid communication with both the first and second piston housings;
wherein movement of the first and second pistons in the first and second piston housings displaces a fluid to interact with the at least one electric generator to generate electricity therefrom.

2. The system of claim 1, wherein the first and second plungers of the first and second pistons comprise doors that are movable between open and closed positions to be able to create ballasts within the pistons.

3. The system of claim 2, wherein the opening of the doors of the first and second pistons allows a liquid to pass through an open upper end of the pistons and creates a ballast to increase the buoyancy of the first and second pistons to allow the piston to move vertically upward.

4. The system of claim 2, wherein the closing of the doors of the first and second pistons traps the liquid by not allowing it to pass therethrough thus increasing the weight of the first and second pistons as it moves vertically downward.

5. The system of claim 1, wherein the at least one electric generator comprises a hydro-turbine.

6. The system of claim 5, wherein the hydro-turbine comprises:
a. a Pelton turbine;
b. a Francis turbine;
c. a Kaplan turbine; or
d. a moment power wheel generator.

7. The system of claim 1, wherein the first and second volume displacers comprise reciprocating pumping kind of mechanisms.

8. The system of claim 1, further comprising a first penstock between the first rod portion of the first piston housing and the at least one electric generator and a second penstock between the second rod portion of the second piston housing and the at least one electric generator to direct a liquid from the first and second rod portions to the at least one electric generator upon movement of the first or second piston rods, and wherein the first and second penstocks include adjustable valves.

9. The system of claim 1, wherein the first and second pistons comprise spring-loaded landing pads at lower ends thereof.

10. A method for generating power, comprising:
moving a first piston vertically in a first piston housing to displace a first liquid by a plunger extending from the first piston in the first piston housing towards and through a turbine generator;
moving a second piston vertically in a second piston housing to displace a second liquid by a plunger extending from the second piston in the second piston housing towards and through the turbine generator;
wherein the first and second pistons move downwardly after liquid is removed from an area under a portion of the pistons and move upwardly by the addition of liquid under the portion of the pistons, and wherein the liquid is removed and added by a first volume displacer connected to the first piston housing and a second volume displacer connected to second piston housing; and
wherein the first and second pistons move vertically in an alternating manner.

11. The method of claim 10, wherein the turbine generator comprises:
a. a Pelton turbine;
b. a Francis turbine;
c. a Kaplan turbine; or
d. a moment power wheel generator.

12. The method of claim 10, further comprising moving the displaced first and second liquids via a first penstock connected to the first piston housing and a second penstock connected to the second piston housing.

13. The method of claim 10, further comprising opening a door at the lower end of the first and second pistons to aid in moving the pistons vertically upward by allowing water to pass through while leveraging on the buoyancy within the main piston housing.

14. The method of claim 10, further comprising closing a door at a lower end of the first and second pistons to create ballasts and increase the weight of the first and second pistons while moving vertically downward.

15. The method of claim 10, wherein the first and second pistons comprise air-sealed rodlike tanks extending downward from the pistons, and wherein the first and second air-sealed rodlike tanks displace the liquid.

16. A system for generating electricity, comprising:
a first piston housing including a plunger housing portion and a rod housing portion, the rod housing portion containing an amount of water;
a first piston housed in the first piston housing, the first piston comprising a convertible plunger and an air-sealed rod-like tank extending into the rod-shaped housing portion of the first piston housing;
a first volume displacer fluidly connected to the plunger portion of the first piston housing to add and remove a liquid therefrom; and
a turbine generator in fluid communication with the rod portion of the first piston housing, wherein movement of the first piston in a downward manner displaces the amount of water in the rod portion of the first piston housing to and through the turbine generator to generate electricity.

17. The system of claim 16, further comprising:
a second piston housing including a plunger housing portion and a rod-shaped housing portion, the rod portion containing an amount of water;
a second piston housed in the second piston housing, the second piston comprising a convertible plunger and an air-sealed rod-shaped tank extending into the rod portion of the second piston housing;
a second volume displacer fluidly connected to the plunger portion of the second piston housing to add and remove a liquid therefrom; and
wherein the turbine generator is in fluid communication with the rod-shaped housing portion of the second piston housing, wherein movement of the second piston in a downward manner displaces the amount of water in the rod-shaped housing portion of the second piston housing to and through the turbine generator to generate electricity.

18. The system of claim 16, wherein the convertible plunger of the first piston comprises a movable door to selectively open allow liquid to pass through or to close to create a ballast to increase the weight of the first piston.

19. The system of claim 16, wherein the first volume displacer comprises a reciprocating pumping mechanism such as a motorized screw press or hydraulic press or any similar mechanism.

20. The system of claim 16, wherein the turbine generator comprises:
a. a Pelton turbine;
b. a Francis turbine;
c. a Kaplan turbine; or
d. a moment power wheel generator.
